(19) United States
(12) Patent Application Publication
(10) Pub. No.: US 2014/0110121 A1
(43) Pub. Date: Apr. 24, 2014

(54) New Environmentally Friendly Fluid to Remove Mn3O4 Filter Cake

(71) Applicants: Texas A&M University, College Station, TX (US); Saudi Arabian Oil Company, Dhahran (SA)

(72) Inventors: Abdullah Mohammed Al Moajil, Dhahran (SA); Salaheldin El Katatny, College Station, TX (US); Hisham A. Nasr-El-Din, College Station, TX (US)

(73) Assignees: Texas A&M University, College Station, TX (US); Saudi Arabian Oil Company, Dhahran (SA)

(21) Appl. No.: 14/057,546

(22) Filed: Oct. 18, 2013

Related U.S. Application Data
(60) Provisional application No. 61/716,022, filed on Oct. 19, 2012.

(51) Int. Cl. C09K 8/528; E21B 37/06

(52) U.S. Cl. CPC C09K 8/528; E21B 37/06
USPC 166/312; 507/201; 507/266

(57) ABSTRACT

Disclosed is a two-stage filter cake removal composition, and method of use thereof, for use in a wellbore for controlled removal of a filter cake present in a target production zone. The two-stage filter cake removal composition may include an enzyme present in an amount of between about 1% and 10%, and a glycolic acid in amounts of between about 1% and 10% by weight. Optionally, hydrochloric acid may be added to the glycolic acid, in an amount of about 1 and 5% by weight. The two-stage filter cake removal composition, when the enzyme is applied to the filter cake in the target production zone in a first stage and the glycolic acid is applied to the filter cake in the target production zone in a second stage, is operable to remove the filter cake in the target production zone over a predetermined extended reaction time.

### CROSS-REFERENCE TO RELATED APPLICATIONS

The present application relates to, claims the benefit of, and claims priority to U.S. Provisional Patent Application Ser. No. 61/716,022, filed Oct. 19, 2012, titled “New Environmentally Friendly Fluid to Removed Mn₃O₄ Filter Cake,” and which is incorporated herein in its entirety.

### FIELD OF THE INVENTION

Embodiments of the invention generally relate to methods and compositions for removing a completion fluid filter cake in a wellbore, and more particularly, to methods and compositions for dissolving or removing filter cake material generated by a manganese-tetraoxide-based drilling fluid in a wellbore for optimizing production from a surrounding hydrocarbon bearing formation.

### BACKGROUND OF THE INVENTION

Horizontally/multilaterally-drilled wells have been used to enhance both hydrocarbon recovery and total well productivity from many types of reservoirs. Drilling, workover, and production operations may result in near-wellbore formation damage that in most cases cannot be prevented (e.g., pore plugging by calcium carbonate particles from drilling fluid, drilled solid particles, or particles from the formation).

During well operations, drilling fluids can be lost into the surrounding formation. To prevent this, the drilling fluid is frequently modified such that a small amount of the fluid and solids contained therein form a coating on a wellbore surface (i.e., the formation of a “filter cake”). After the completion of drilling operations, the coating or filter cake is typically removed, and production from the formation can proceed. The process used to remove the filter cake can also be used to remove other types of damage or debris from the wellbore prior to beginning hydrocarbon production.

To facilitate the drilling of horizontal/multilateral wells, weighting materials have been introduced into the drilling fluid to increase the density of the drilling fluid for balancing the hydrostatic pressure and for maintaining stability within the wellbore to minimize formation damage and corrosion in the wellbore. Several weighting materials (e.g., bentonite, barite, calcium carbonate (CaCO₃), ilmenite, and hematite) have been used in drilling fluids, each of which has several associated limitations. For example, bentonite and barite are not soluble in certain acids, such as hydrochloric acid (HCl), and therefore they may cause formation damage in the wellbore. The specific gravity of CaCO₃ (e.g., 2.71) limits its application when a high density drilling fluid is needed to drill deep wells. Due to the partial solubility of barite in concentrated formate brines and the conventional practice not to acidize the wellbore prior to completion of the well, CaCO₃ and barite have been excluded as options to increase density of the drilling fluid in many applications.

Manganese tetraoxide (Mn₃O₄) is a high density, acid-soluble weighting material useful in drilling fluids for drilling high temperature/high pressure (HT/HP) wells. Mn₃O₄ is spherical in shape, has an average partial size of 1-5 microns, and a specific gravity of 4.8. These properties make it appropriate for drilling deep wells. For example, Mn₃O₄ has been introduced into potassium formate drilling fluids to overcome the main drawback of potassium formate, which is the production of a brine of density 1.7 g/cm³ (106 lb/ft³). Mn₃O₄ has also been introduced as a weighting material into oil-based drilling fluids due to its ability to lower the plastic viscosity of the oil-based drilling fluid. A water-based drilling fluid weighted with Mn₃O₄ and a small amount of CaCO₃ has also been formulated for use in a wellbore. CaCO₃ has been added to the water-based drilling fluid to control filtration properties of the drilling fluid. A drilling fluid with high rheological properties has been achieved using Mn₃O₄ particles.

Mn₃O₄ particles, however, also present many disadvantages as a weighting material in oil-based or water-based drilling fluids. For example, Mn₃O₄ particles aggregate up to 20 microns in aqueous and oil-based fluids. Accumulation of these aggregates in the critical near wellbore area can result in stuck pipe and mud cake problems during drilling operations. Dust problems associated with the accumulation of these aggregates have also caused formation damage in the wellbore. Additionally, starch may be present in the filter cake covered Mn₃O₄ particles, which can contribute to additional particle agglomeration. Thus, addressing the removal of a filter cake formed by a drilling fluid weighted with Mn₃O₄ particles is essential to ensure the effectiveness of drilling and cleaning operations in the wellbore.

Several cleaning compositions have been developed to remove the filter cake generated by a manganese-tetraoxide-based drilling fluid from the wellbore and to minimize formation damage in the wellbore using live acids, gelled acids, strongly buffered organic acids, chelating agents, oxidizing agents, enzymes, in-situ generated organic acids, microemulsions, or combinations of these chemicals. Because Mn₃O₄ is a strong oxidizing agent having an active phase (i.e., a tetragonal symmetry, non-stoichiometry behavior) locally composed of an octahedral Mn₂O₃ phase and a tetrahedral MnO phase, it experiences complex interactions with most cleaning fluids, including the aforementioned chemicals. For example, organic acids and chelating agents will not independently dissolve Mn₃O₄-based filter cakes. Ethylene diamine tetracetic acid (EDTA) at high pH (e.g., a pH of 12) and acetic, propionic, butyric, and gluconic acids at low pH (e.g., a pH of 3-5) exhibit very low solubility. Glutamic, citric, oxalic, and tartaric acids produce white precipitation when reacted with Mn₃O₄ particles. Similarly, diethylene triamine pentaacetic acid (DTPA) precipitates manganese silicate if used to dissolve Mn₃O₄-based filter cake in a sandstone formation.

Citric acid in an amount of about 10% by weight has been used as a cleaning fluid for effectively removing a filter cake. However, when reacted with Mn₃O₄, citric acid has been known to dissociate insoluble manganese citrate causing formation damage in the wellbore, and therefore is not a suitable composition to effectively dissolve or remove the Mn₃O₄-based filter cake from the wellbore while preventing formation damage.

Therefore, what is needed is a filter cake removal composition which dissolves, and more preferably removes, a filter cake generated by a manganese-tetraoxide-based drilling fluid without causing formation damage in the wellbore.

### SUMMARY OF THE INVENTION

Embodiments of the invention are directed to compositions, and methods of use thereof, for dissolving or removing filter cake material generated by a manganese-tetraoxide-based drilling fluid in a wellbore for optimizing production from a surrounding hydrocarbon bearing formation. An embodiment of the invention includes a two-stage filter cake removal composition which includes an enzyme that is first applied to the filter cake, followed by the application of a glycolic acid to the resulting filter cake. According to another embodiment of the invention, there is provided a two-stage filter cake removal composition that has been demonstrated to remove filter cake material generated by a manganese-tetraoxide-based drilling fluid in a wellbore using the application of an amylase enzyme in a first stage, followed by the application of a glycolic acid in a second stage, which will also be described in further detail below. In another embodiment of the invention, the glycolic acid is mixed with hydrochloric acid before application. Methods of using the filter cake removal compositions will also be described in further detail below.

Another embodiment of the present invention is a one-stage filter cake removal composition for use in a wellbore for controlled removal of a filter cake present in a target production zone, the one-stage filter cake removal composition comprising a glycolic acid and a hydrochloric acid. In this one-stage filter cake removal composition, the glycolic acid and the hydrochloric acid are applied to the filter cake in the target production zone in a single stage.

There is provided a two-stage filter cake removal composition, in accordance with an embodiment of the invention, for use in a wellbore for controlled removal of a filter cake present in a target production zone. The two-stage filter cake removal composition includes an enzyme and a glycolic acid. The two-stage filter cake removal composition, when the enzyme is applied to the filter cake in the target production zone in a first stage and the glycolic acid is applied to the filter cake in the target production zone in a second stage, is operable to remove the filter cake in the target production zone over a predetermined extended reaction time.

In accordance with another embodiment of the invention, there is provided a method for the controlled removal of a filter cake from a target production zone of a wellbore using a two-stage filter cake removal composition. The method includes delivering the two-stage filter cake removal composition to the target production zone. The two-stage filter cake removal composition contacts the filter cake for a predetermined extended reaction time during which predetermined extended reaction time the two-stage filter cake removal composition acts to remove the filter cake and after which predetermined extended reaction time the two-stage filter cake removal composition acts to control fluid loss from the wellbore into the target production zone. The step of delivering includes applying an enzyme of the two-stage filter cake removal composition to the filter cake in the target production zone in a first stage and applying a glycolic acid of the two-stage filter cake removal composition to the filter cake in the target production zone in a second stage.

In another embodiment of the invention, the glycolic acid is mixed with hydrochloric acid before application in the above described embodiments.

### BRIEF DESCRIPTION OF DRAWINGS

So that the manner in which the features and advantages of the invention, as well as others which will become apparent, may be understood in more detail, a more particular description of the invention briefly summarized above may be had by reference to the embodiments thereof which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1 shows the effect of glycolic acid on the dissolution of manganese ions at 190° F.

FIG. 2 shows a computer tomography scan of a filter cake which shows a heterogeneous manganese tetraoxide filter cake with a polymer (e.g. starch) layer formed close to the drilling fluid.

FIG. 3 shows a filter cake before application of a two-stage filter cake removal composition, after application of an enzyme of a two-stage filter cake removal composition, and after an application of a two-stage filter cake removal composition, in accordance with an embodiment of the invention.

FIG. 4 shows a filter cake before and after an application of a one-stage filter cake removal composition, in accordance with an embodiment of the invention

FIG. 5 shows a graph showing the retained permeability after treatment with a mixture of glycolic acid. The decreased leak-off time after the removal process indicates the stimulation of the core.

### DETAILED DESCRIPTION OF THE INVENTION

Although the following detailed description contains many specific details for purposes of illustration, it is understood that one of ordinary skill in the relevant art will appreciate that many examples, variations, and alterations to the following details are within the scope and spirit of the invention. Accordingly, the exemplary embodiments of the invention described herein are set forth without any loss of generality, and without imposing limitations, relating to the claimed invention.

As used herein, the term “drilling fluid” shall be used to collectively refer to a completion fluid or a drilling fluid. As understood in the art, “drilling fluid” shall be used to describe a fluid used to aid in the drilling of a borehole for a well (e.g., a horizontal/multilateral well). The drilling fluid may include a water-based mud (e.g., a dispersed or non-dispersed water-based mud), a non-aqueous mud (e.g., an oil-based mud), and a gaseous drilling fluid.

It has been observed that, in normal operations, the Mn₃O₄ particles of the filter cake are covered with polymeric material (e.g., starch), which significantly reduces the solubility of the filter cake in the organic acids. Therefore, there is a need to remove the polymeric material on the Mn₃O₄ particles of the filter cake to more effectively dissolve or remove the filter cake material in the wellbore. Embodiments of the invention provide for the application of an enzyme (i.e., an enzyme that catalyzes the breakdown of starch into sugars) to remove the polymeric material present on the Mn₃O₄ particles of the filter cake.

Glycolic acid has a unique set of properties that makes it ideal for a broad range of applications. Glycolic acid has a dissolving power that is comparable to lactic acid. Additionally, glycolic acid exhibits low corrosion to most common metals, is environmentally friendly, and biodegrades at a rate of 90% in 7 days.

Embodiments of the invention provide a two-stage filter cake removal composition, and method of use thereof, for use in the wellbore for controlled removal of the filter cake present in the target production zone. Generally, the two-stage filter cake removal composition includes an enzyme and a glycolic acid. The two-stage filter cake removal composition, when the enzyme is delivered or applied to the filter cake in the target production zone in a first stage and the glycolic acid is applied to the filter cake in the target production zone in a second stage, is operable to remove the filter cake in the target production zone over a predetermined extended reaction time. Subsequently, the delivery or application of the two-stage filter cake removal composition is operable to control fluid loss from the wellbore into the target production zone.

Another embodiment of the invention relates to a method for the controlled removal of a filter cake from a target production zone of a wellbore using a two-stage filter cake removal composition. In the method, the two-stage filter cake removal composition is delivered to the target production zone. The two-stage filter cake removal composition contacts the filter cake for a predetermined extended reaction time during which extended time the two-stage filter cake removal composition acts to remove the filter cake and after which predetermined extended reaction time the two-stage filter cake removal composition acts to control fluid loss from the wellbore into the target production zone. In this method, the delivering comprises applying an enzyme of the two-stage filter cake removal composition to the filter cake in the target production zone in a first stage and applying a glycolic acid of the two-stage filter cake removal composition to the filter cake in the target production zone in a second stage.

In accordance with another embodiment of the invention, the glycolic acid is present in an amount of about 10% by weight, preferably in an amount of between about 2 and 6% by weight, more preferably about 5% by weight, and most preferably about 4% by weight. According to an embodiment of the invention, the glycolic acid may also be mixed with hydrochloric acid. When mixed with hydrochloric acid, the glycolic acid is present in an amount of between about 4% and 10% by weight. The hydrochloric acid is present in an amount of between about 1-5% by weight.

Another embodiment of the present invention is a one-stage filter cake removal composition for use in a wellbore for controlled removal of a filter cake present in a target production zone, the one-stage filter cake removal composition comprising a glycolic acid and a hydrochloric acid. In this one-stage filter cake removal composition, when the glycolic acid and the hydrochloric acid are applied to the filter cake in the target production zone in a single stage, the composition is operable to remove the filter cake in the target production zone over a predetermined extended reaction time. This predetermined extended reaction time can be up to 16 hours. In this one stage approach, different acid concentrations may be used than in the two stage approach. For instance, 4% by weight glycolic acid and 2% by weight hydrochloric acid are usually sufficient to yield comparable results as 5% by weight glycolic acid used in a two stage treatment process.

According to an embodiment of the invention, about 10% by weight glycolic acid may dissolve, in a two-stage filter cake removal treatment of the filter cake, about 85% by weight of the Mn₃O₄-based filter cake after about 18-22 hours of soaking at a temperature of about 250° F. and a pressure of about 250 psi.

According to an embodiment of the invention, about 4% by weight glycolic acid mixed with 1% by weight of hydrochloric acid may dissolve, in a one-stage filter cake removal treatment of the filter cake, about 90% by weight of the Mn₃O₄-based filter cake after about 18-22 hours of soaking at a temperature of about 250° F. and a pressure of about 250 psi.

In accordance with an embodiment of the invention, the enzyme includes an enzyme that catalyzes the breakdown of starch into sugars to remove the polymeric material present on the Mn₃O₄ particles of the filter cake for more effectively dissolving or removing the filter cake material in the wellbore. According to an embodiment of the invention, the enzyme includes an amylase enzyme present in an amount of between about 1% and 10% by weight. The amylase enzyme may include, for example, an α-amylase enzyme, a β-amylase enzyme, or a γ-amylase enzyme. In a preferred embodiment, the enzyme of the two-stage filter cake removal composition is an α-amylase enzyme present in an amount of about 10% by weight. In some embodiments, a stabilizer can be added to the enzyme composition.

In accordance with certain embodiments of the invention, the enzyme is applied to the filter cake in the target production zone for a first predetermined period of time based on one of a characteristic of the filter cake, an enzyme type, concentration of the enzyme, and the thermal stability of the enzyme. For example, the enzyme may be applied to the filter cake for a first predetermined period of time of up to about 24 hours, preferably for about 16-24 hours, and more preferably about 20 hours.

In accordance with certain embodiments of the invention, the glycolic acid or glycolic acid and hydrochloric acid composition is applied to the filter cake in the target production zone for a second predetermined period of time. For example, the glycolic acid or glycolic acid and hydrochloric acid composition may be applied to the filter cake for a second predetermined period of time of up to about 24 hours, preferably for about 16-24 hours, and more preferably about 20 hours.

In accordance with certain embodiments of the invention, the concentrations of the enzyme, the glycolic acid, and the hydrochloric acid are based on one or more factors, including, but not limited to, the reservoir temperature, formation mineralogy and composition, filter cake characteristics and composition, enzyme activity, and thermal stability.

### EXAMPLES

### Example 1

The examples described below show certain exemplary embodiments of the filter cake removal composition of the present invention, as described herein. As shown in Table 1, water-based drilling fluids primarily weighted with Mn₃O₄ and a small amount of CaCO₃ particles to control a leak-off rate were prepared to demonstrate the efficacy of the filter cake removal composition, in accordance with certain embodiments of the invention, for dissolving or removing filter cake material in a wellbore. Xanthan, starch, and polyanionic cellulose (PAC-R) polymers were added to the mud to control fluid loss and rheological properties of the drilling fluid. Potassium hydroxide (KOH) was added to adjust the pH of the drilling fluid. Sodium sulfite (Na₂SO₃) was added to the drilling fluid as an oxygen scavenger.

TABLE 1
TABLE 1 - FORMULATION OF DRILL-IN FLUID

| Additive | Function | Quantity (gm) |
|---|---|---|
| Water | Base | 287.7 |
| Deformer | Anti-foam | 0.08 |
| Xanthan | Viscosifier | 1 |
| Starch | Fluid loss control | 6 |
| | agent | |
| PAC-R | Viscosifier/fluid loss | 0.75 |
| KCl | Density and shale | 41 |
| | inhibition | |
| KOH | pH control | 0.5 |
| CaCO₃ | Weighting material | 3.5 |
| (Fine) | | |
| CaCO₃ | Weighting material | 1.5 |
| (Medium) | | |
| Mn₃O₄ | Weighting material | 205 |
| Na₂SO₃ | Oxygen scavenger | 0.75 |

Table 2 summarizes the main properties of the prepared manganese-tetraoxide-based drilling fluid shown above in Table 1.

TABLE 2
TABLE 2 - PROPERTIES OF Mn₃O₄ DRILL-IN FLUID

| Property | Conditions | Unit | Value |
|---|---|---|---|
| Density | 75° F. and 14.7 psi | lb/ft³ | 95 |
| Plastic | 120° F. and 14.7 psi | cp | 27 |
| viscosity | | | |
| Yield | | lb/100 ft² | 33 |
| point | | | |
| 10 s gel | | lb/100 ft² | 9 |
| strength | | | |
| 10 s gel | | lb/100 ft² | 11 |
| strength | | | |
| pH | 75° F. and 14.7 psi | — | 10-11 |

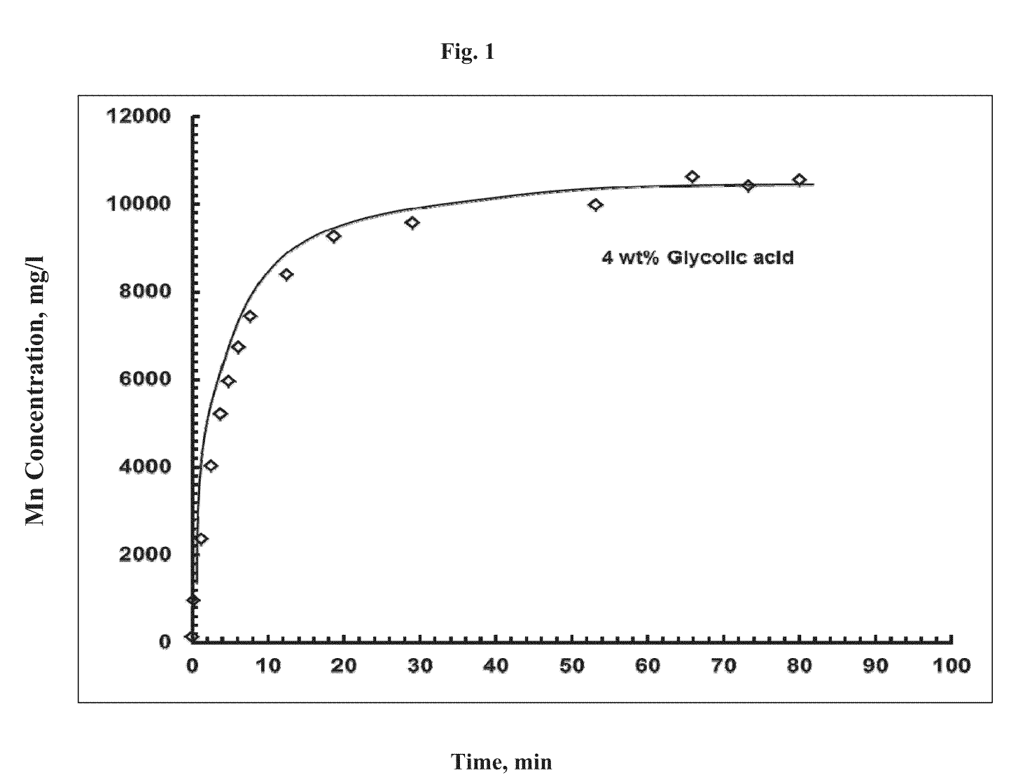

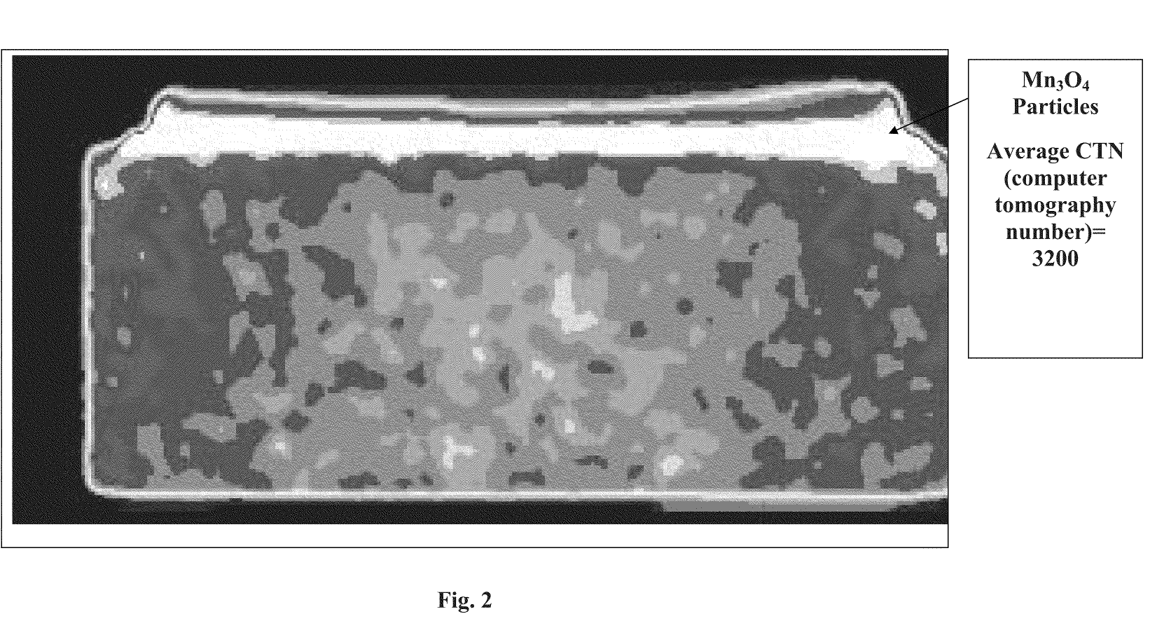

According to various embodiments of the invention, glycolic acid is effective for dissolving Mn₃O₄ particles and the Mn₃O₄-based filter cake. For example, as shown in Table 3, glycolic acid effectively dissolves Mn₃O₄ particles. A 4% by weight composition of glycolic acid dissolved Mn₃O₄ particles with up to 76% by weight at 190° F. Adding 1% by weight of hydrochloric acid to 4% by weight of glycolic acid increased dissolved solids to 99%. The effect of 4% by weight of glycolic acid on manganese ion concentration is further shown in FIG. 1.

TABLE 3
TABLE 3 - SOLUBILITY OF Mn₃O₄ PARTICLES IN
ACID SOLUTIONS, 190° F.

| | Dissolved | % of acid | Manganese |
|---|---|---|---|
| Acid type, wt % | solids, wt % | consumed | Concentration, mg/l |
| 4 wt % glycolic acid | 99 | — | 14,600 at 10 min. |
| mixed with 1 wt % | | | |
| HCl | | | |
| 4 wt % glycolic acid | 74.5 | 66.5 | 10,000 at 10 min. |

### Example 2

Certain embodiments of the invention provide a two-stage filter cake removal composition for controlled removal of a filter cake present in a target production zone. As previously discussed above, Mn₃O₄ particles in the filter cake may be covered with polymeric material (e.g., starch), which significantly reduces the solubility of the filter cake in organic acids. In order to remove the polymeric material, embodiments of the invention provide a two-stage filter cake removal composition which includes the application of an enzyme in a first stage and the application of a glycolic acid in a second stage.

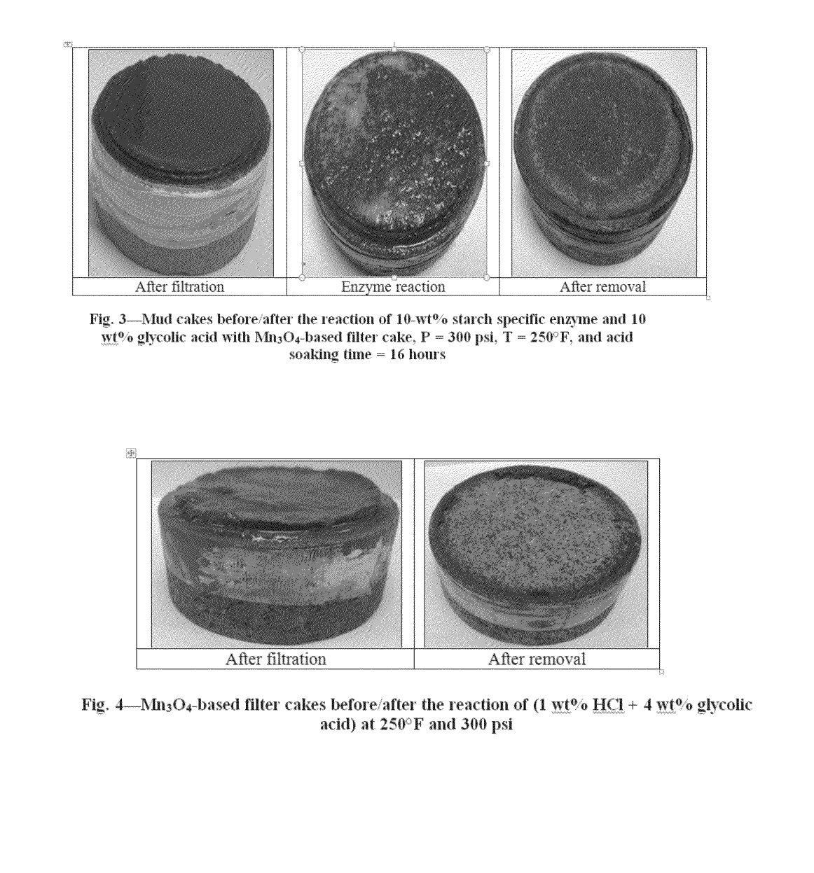

Experimentation demonstrated that an amylase enzyme in an amount of about 10% by weight and a stabilizer in a first stage soaking of about 20 hours followed by glycolic acid (10% by weight) dissolved 88% by weight of the filter cake at about 250° F. (121° C.) and 300 psi, after soaking the filter cake in the organic acid for about 16 hours (see FIG. 3).

### Example 3

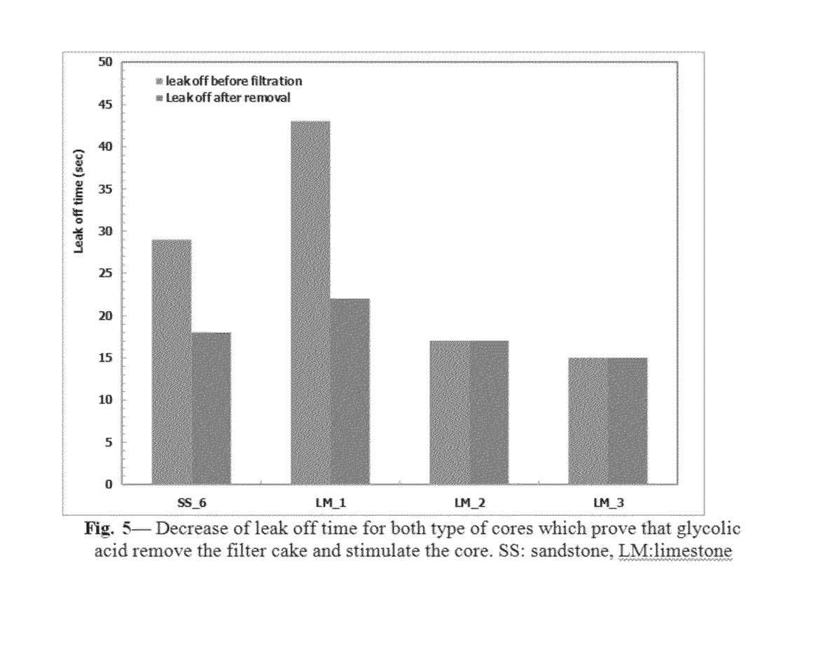

Experimentation demonstrated that glycolic acid (4% by weight) and hydrochloric acid (1% by weight) dissolved 87% by weight of the Mn₃O₄-based filter cake after 18 hours of soaking time at about 250° F. (121° C.) and 300 psi, in a one-stage treatment process, as shown in FIG. 4.

### Example 4

Samples also showed that the retained permeability was 100%, as shown in FIG. 5. The limestone samples shown in FIG. 5 were Indiana limestone cores (LM) and the sandstone sample was a Brea sandstone core (SS). The Indiana limestone were cut from a block with an average porosity 23 vol % and an average permeability of 3-5 mD. The Brea sandstone core had an average porosity of 15 vol % and an average permeability of 50-60 mD. The SS sample, and LM samples 1 and 2 were treated with 10 wt % glycolic acid. LM sample 3 was treated with 5% glycolic acid.

Embodiments of the present invention may suitably comprise, consist or consist essentially of the elements disclosed and may be practiced in the absence of an element not disclosed. For example, it can be recognized by those skilled in the art that certain steps can be combined into a single step.

Unless defined otherwise, all technical and scientific terms used have the same meaning as commonly understood by one of ordinary skill in the art to which this invention belongs.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A two-stage filter cake removal composition for use in a wellbore for controlled removal of a filter cake present in a target production zone, the two-stage filter cake removal composition comprising:
an enzyme; and
a glycolic acid,
wherein the two-stage filter cake removal composition, when the enzyme is applied to the filter cake in the target production zone in a first stage and the glycolic acid is applied to the filter cake in the target production zone in a second stage, is operable to remove the filter cake in the target production zone over a predetermined extended reaction time.

2. The two-stage filter cake removal composition of claim 1, wherein the enzyme comprises an amylase enzyme present in an amount of between about 1% and 10% by weight.

3. The two-stage filter cake removal composition of claim 1, wherein the enzyme is selected from the group consisting of an α-amylase enzyme, a β-amylase enzyme, and a γ-amylase enzyme.

4. The two-stage filter cake removal composition of claim 1, wherein the enzyme comprises an α-amylase enzyme present in an amount of about 10% by weight.

5. The two-stage filter cake removal composition of claim 1, wherein the glycolic acid is present in an amount of between about 0.1% and 2% by weight.

6. The two-stage filter cake removal composition of claim 1, wherein the enzyme further comprises a stabilizer.

7. The two-stage filter cake removal composition of claim 1, wherein the glycolic acid further comprises a hydrochloric acid.

8. The two-stage filter cake removal composition of claim 8, wherein the hydrochloric acid is present in an amount of between about 0.1% and 1.0% by weight.

9. The two-stage filter cake removal composition of claim 8, wherein the filter cake removal composition comprises the mixture of the hydrochloric acid present in an amount of about 1% by weight and the glycolic acid present in an amount of about 4% by weight.

10. A method for the controlled removal of a filter cake from a target production zone of a wellbore using a two-stage filter cake removal composition, the method comprising:
delivering the two-stage filter cake removal composition to the target production zone, in an amount operable to control fluid loss,
wherein the two-stage filter cake removal composition contacts the filter cake for a predetermined extended reaction time during which predetermined extended reaction time the two-stage filter cake removal composition acts to remove the filter cake and after which predetermined extended reaction time the two-stage filter cake removal composition acts to control fluid loss from the wellbore into the target production zone, and
wherein the delivering comprises applying an enzyme of the two-stage filter cake removal composition to the filter cake in the target production zone in a first stage and applying a glycolic acid of the two-stage filter cake removal composition to the filter cake in the target production zone in a second stage.

11. The method of claim 10, wherein the delivering further comprises applying the enzyme present in an amount of between about 1% and 10% by weight to the filter cake in the target production zone for a predetermined period of time based on one of a characteristic of the filter cake, an enzyme type, concentration of the enzyme, and the thermal stability of the enzyme.

12. The method of claim 10, wherein the delivering further comprises applying an amylase enzyme present in the amount of about 10% by weight to the filter cake in the target production zone for a predetermined extended reaction time of about 20 hours.

13. The method of claim 10, wherein the enzyme is selected from the group consisting of an α-amylase enzyme, a β-amylase enzyme, and a γ-amylase enzyme.

14. The method of claim 10, wherein the delivering further comprises applying the glycolic acid present in an amount of between about 1.0% and 10% by weight.

15. The method of claim 14, wherein the glycolic acid further comprises a hydrochloric acid present in an amount of between about 0.1 and 1% by weight.

16. The method of claim 15, wherein the delivering further comprises applying the glycolic acid present in the amount of about 4% by weight and the hydrochloric acid present in the amount of about 1.0% by weight.

17. The method of claim 10, wherein the applying the enzyme comprises applying the enzyme of the two-stage filter cake removal composition to the filter cake in the target production zone for a first predetermined extended reaction time based on one of a characteristic of the filter cake, an enzyme type, concentration of the enzyme, and the thermal stability of the enzyme, wherein the enzyme concentration of the two-stage filter cake removal composition is between about 1% and 10% by weight, and
wherein the applying the mixture comprises soaking, after applying the enzyme, the filter cake in the target production zone with the glycolic acid for a second predetermined extended reaction time, wherein the concentration of glycolic acid is between about 1% and 10% by weight.

18. The method of claim 17, wherein the enzyme concentration is about 10%, the concentration of the glycolic acid is about 10%, respectively, by weight, for the filter cake removal composition.

19. The method of claim 17, wherein the first predetermined extended reaction time is about 20-24 hours and the second predetermined extended reaction time is about 20-24 hours.

20. The method of claim 17, wherein the glycolic acid is present in the amount of about 4% by weight and further wherein hydrochloric acid is present in an amount of about 1% by weight and is applied to the filter cake in the target production zone at or about the same as the glycolic acid.

21. A one-stage filter cake removal composition for use in a wellbore for controlled removal of a filter cake present in a target production zone, the one-stage filter cake removal composition comprising:
a glycolic acid,
a hydrochloric acid;
wherein the one-stage filter cake removal composition, when the glycolic acid and the hydrochloric acid are applied to the filter cake in the target production zone in a single stage, is operable to remove the filter cake in the target production zone over a predetermined extended reaction time.
